(19) United States
(12) Patent Application Publication
(10) Pub. No.: US 2005/0074552 A1
(43) Pub. Date: Apr. 7, 2005

(54) Photoresist coating process for microlithography

(76) Inventors: Howard Ge, Canoga Park, CA (US); Christine Geosling, Calabasas, CA (US)

Correspondence Address: SNELL & WILMER LLP, 1920 MAIN STREET, SUITE 1200, IRVINE, CA, 92614-7230, US

(21) Appl. No.: 10/680,960

(22) Filed: Oct. 7, 2003

(51) Int. Cl. B05D 3/12; B05D 3/02; G03C 5/00

(52) U.S. Cl. 427/240; 427/385.5

(57) ABSTRACT

A photoresist spray coating process for deep trenched substrates. According to one implementation of the invention, the substrate surface is primed with a primer having a water contact angle between forty and fifty degrees. A spray nozzle is moved across the diameter of the substrate at varying speeds to achieve a coat of substantially the same thickness throughout. The photoresist is spray coated on the substrate surface at an angle to the substrate surface to obtain coverage of deep etched features. The photoresist is dissolved in a solvent according to specific dilution ratios to achieve a viscosity range that permits spraying the photoresist evenly in deep etch features while avoiding pull-back.

### FIELD

Various embodiments of the invention pertain to microlithography methods. At least one embodiment of the invention pertains to a method for producing relatively even spray coverage in deep-featured substrates used in microlithography.

### DESCRIPTION OF RELATED ART

In the semiconductor industry, microlithography has been used to produce patterns on substrates for the production of semiconductor devices. The fabrication of such semiconductor devices typically involves processing wafers by coating them with a photoresist solution. Photoresist solution, also commonly referred to as “resist”, is used for masking the wafer during various processes, including, an etching process, an ion implantation process and a metalization process. Photoresist is typically applied to a wafer by a spin coating technique in which photoresist solution is dispensed while the wafer is spun on a rotating plate. The thickness of the photoresist on the wafer can be varied depending on the flow rate through the orifice, the rotation rate of the plate, and dispense time.

Basic lithography systems typically include a source of light, typically not visible light (e.g., ultraviolet), a stencil or photomask including a pattern to be transferred to a substrate, a collection of lenses, and a means for aligning existing patterns on the substrate with patterns on the mask or stencil. Conventional photomasks typically include chromium patterns on a quartz plate, allowing light to pass wherever the chromium has been removed from the mask. Light of a specific wavelength is projected through the mask onto the photoresist-coated substrate, exposing the photoresist wherever chromium has been removed from the mask permitting light to pass through the mask. Exposing the resist to light of the appropriate wavelength causes modifications in the molecular structure of the resist polymers, which permits the use of developer to dissolve and remove the resist in the exposed areas. Resists that act as just described are known as “positive” resists. On the other hand, negative resist systems permit only unexposed areas to be removed by the developer.

Micro-machined devices, such as accelerometers, gyroscopes, and miniature engines, have created a need for highly precise, small electromechanical parts that can be mass-produced. Microlithography has been employed in microfabrication processes to create these micro-machined mechanical devices and systems. Microfabrication processes, which are typically associated with manufacturing of integrated circuits, generally include processes capable of producing components and assemblies with micron-sized features and producing a plurality of assemblies or components simultaneously or in “batches”. The fine dimensional tolerances of microfabrication processes means that miniaturized machines can be created. The ability to produce multiple parts simultaneously means that these machines may be produced efficiently and in great numbers; batching leads to economy-of-scale reduction in the production costs.

As with semiconductor devices, wafers are coated with photoresist and then etched to create the desired electrical component or mechanical part. This typically involves the process of patterning openings or grooves in photosensitive polymers, sometimes referred to as “photoresists” or “resists”, which define small areas in which substrate material is modified by a specific operation in a sequence of processing steps.

A photoresist can be a negative or positive photoresist material. A negative photoresist material is one which is capable of polymerizing and being rendered insoluble upon exposure to radiation. Accordingly, when employing a negative photoresist material, the photoresist is selectively exposed to radiation, causing polymerization to occur above those regions of the substrate which are intended to be protected during a subsequent operation. The unexposed portions of the photoresist are removed by a solvent which is inert to the polymerized portion of the photoresist. Such a solvent may be an aqueous solvent solution. Positive photoresist material is a material that, upon exposure to radiation, is capable of being rendered soluble in a solvent in which the unexposed resist is not soluble. Accordingly, when applying a positive photoresist material the photoresist is selectively exposed to radiation, causing the reaction to occur above those portions of the substrate which are not intended to be protected during the subsequent processing period. The exposed portions of the photoresist are removed by a solvent which is not capable of dissolving the exposed portion of the resist. Such a solvent may be an aqueous solvent solution.

### SUMMARY OF THE INVENTION

One implementation of the invention provides a method for coating a wafer having deep trench features with photoresist. A first aspect of the invention that enables deep trench coating provides a range of dilution ratios for photoresist to be sprayed on the substrate. A second aspect of the invention provides a method for priming and spray coating photoresist on a substrate having deep-trench and/or via features. A third aspect of the invention permits spray coating photoresist in an environment having relatively high humidity.

According to one implementation of the invention, the substrate surface is primed with a primer having a water contact angle between forty and fifty degrees. A spray nozzle is moved across the diameter of the substrate at varying speeds to achieve a coat of substantially the same thickness throughout. The photoresist is spray coated on the substrate surface at an angle to the substrate surface to obtain coverage of deep etched features.

### BRIEF DESCRIPTION OF THE DRAWINGS

FIG. 1 illustrates a system where a substrate is rotated and sprayed with photoresist solution in accordance with one embodiment of the invention.

FIG. 2 illustrates how the present invention may be used with a substrate having both shallow and deep trenches, features, and/or vias.

FIG. 3 illustrates varying the speeds that the spray nozzle traverses a rotating substrate to achieve a substantially uniform photoresist thickness on the substrate according to one embodiment of the invention.

FIG. 4 illustrates the relative contact angle measurements of surfaces primed for spin and spray coating resist.

FIG. 5 illustrates one method of priming a substrate prior to spray coating in relatively high humidity environments according to one embodiment of the invention.

FIG. 6 illustrates a method for depositing photoresist on a substrate according to one embodiment of the invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the micromachining industry, various spin coating techniques are commonly used to coat a wafer surface with photoresist. Such techniques typically involve spinning the substrate in a prescribed fashion while liquid photoresist is dropped onto the substrate's surface. The spin coating process is well understood and can achieve very uniform coating on most surface micromachined substrates having shallow features (i.e., features less than 20 μm deep). However, bulk micromachining processes often require coverage of deep trenches and vias. Conventional spin coating in this case, often results in striation, void formation, and corner build-up or pull-back, and can hinder subsequent etch processes.

One implementation of the invention provides a method for coating a wafer having deep trench features with photoresist. A first aspect of the invention that enables deep trench coating provides a range of dilution ratios for photoresist to be sprayed on the substrate. A second aspect of the invention provides a method for priming and spray coating photoresist on a substrate having deep trench or via features. A third aspect of the invention permits spray coating photoresist in an environment having relatively high humidity.

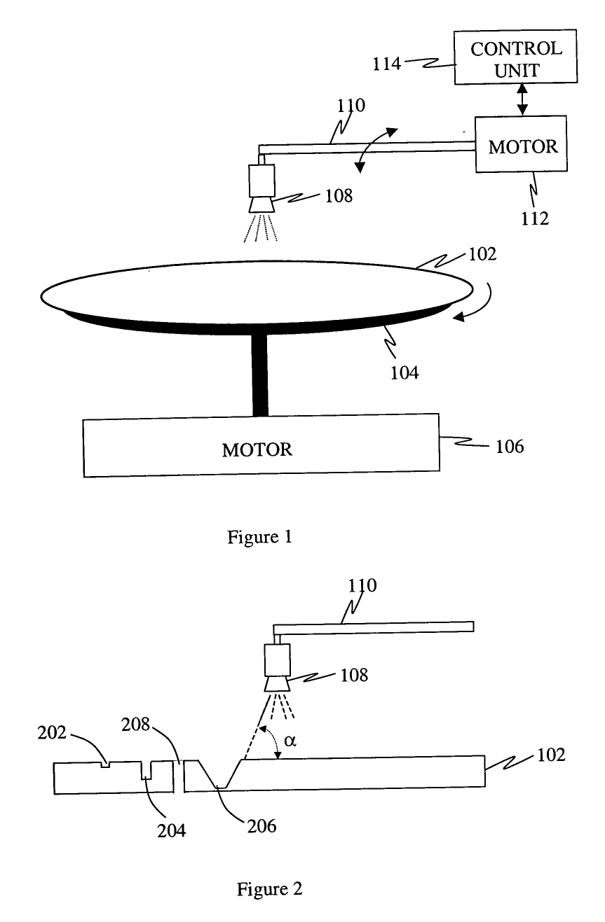

FIG. 1 illustrates a system where a substrate 102 is rotated and sprayed with photoresist solution in accordance with one embodiment of the invention. The substrate 102 (e.g., wafer) is placed on a plate 104 and rotated at a predefined speed by a first motor 106. As the substrate 102 rotates, a spray nozzle 108 moves across the diameter of the substrate 102 and sprays a coat of photoresist on the substrate 102. The spray nozzle 108 is coupled to a swivel arm 110 that moves across the diameter of the substrate 102 and substantially parallel to the surface of the substrate 102.

The spray nozzle 106 is moved back and forth, substantially parallel to the surface of the substrate, on the swivel arm 110 by a motor 112 that is controlled by a control unit 114. The control unit 114 controls the position and speed at which the spray nozzle 108 moves.

FIG. 2 illustrates how the present invention may be used with a substrate 102 having both shallow and deep trenches, features, and/or vias. FIG. 2 illustrates a cross section of the substrate 102 having a plurality of different trenches and vias. For example, the substrate 102 may include a relatively shallow trench 202 (e.g. 20 μm deep), a deep via 204 (e.g. 100 μm deep), a deep angled trench 206 (e.g., 225 μm deep), and/or a through-etched via 208 (e.g., 500 μm deep). Note that the depth of the features that may be attained is a function of the aspect ratio of the diameter or width of a feature versus its depth. Thus, significantly deeper features than those noted above may be attained in some implementations.

According to one aspect of the invention, spray coating is used to coat photoresist over the wafer 102 with deep features (i.e., features greater than 20 μm deep) and overcome the problems (e.g., striation, void formation, and corner build-up or pull-back) often encountered by spin coating. Spray coating deposits fine droplets of photoresist onto the substrate 102. By directing the droplets at an angle α while rotating the substrate 102, photoresist coverage of the top surface and trench sidewalls is maximized. That is, the angle α at which the photoresist droplets are sprayed permits the photoresist to make its way into the deep trenches and vias and coat the sidewalls. Among other factors, this angle α is dependent on the aspect ratios of the features to be coated. The aspect ratios refer to the diameter or size of the features relative to the depth of the feature. According to one implementation, an EV101 Spray Resist System™, manufactured by Electronic Visions Group, may be employed for spraying photoresist at an angle.

One problem with spraying photoresist on a rotating substrate is the difficulty in obtaining an even coat of photoresist throughout the substrate. The quality and precision of micro-machined devices is largely dependent on how evenly the photoresist solution is able to cover the surfaces of interest. Since the region near the edge of the rotating substrate has a greater surface area traversed per unit of time than the region near the center of the substrate, more photoresist would tend to accumulate at the center of the substrate.

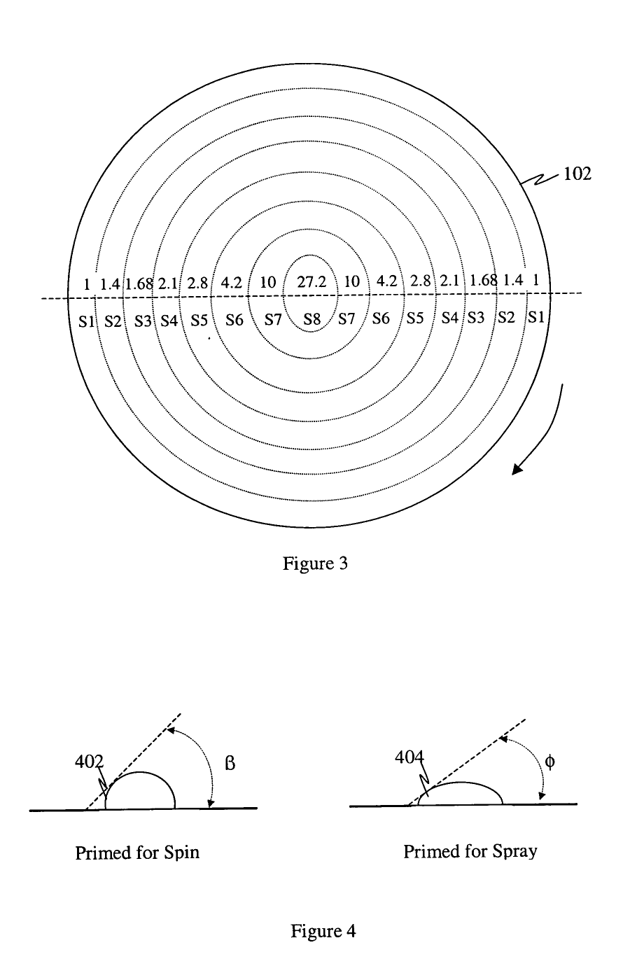

FIG. 3 illustrates varying the speeds that the spray nozzle traverses a rotating substrate to achieve a substantially uniform photoresist thickness on the substrate 102 according to one embodiment of the invention. That is, the speed at which the spray nozzle moves across the diameter of the rotating substrate 102 varies as it moves from the perimeter of the substrate to the center. As the spray nozzle traverses across the diameter of the substrate, it moves at various speeds (e.g., S1, S2, S3, S4, S5, S6, S7, S8, S7, S6, S5, S4, S3, S2, S1, with S1 being the slowest speed and S8 being the fastest speed). For example, in one implementation of the invention the speeds at which the nozzle traverses the substrate diameter are divided into fifteen (15) speeds. To achieve uniformity in the thickness of the photoresist across the entire substrate, slower speeds are used as the nozzle gets closer to the edge since more area is covered there. For instance, at the center of the substrate the spray nozzle may travel at a relative speed S8 that is 27.2 times that of the outer speed S1.

Since the nozzle spray pattern is an annular ring, the travel of the spray nozzle through the center of the substrate should be quick to avoid excessive photoresist building up around the center. For example, for a four (4) inch circular substrate, the swivel arm is moved across the surface of the substrate at varying relative speeds. For instance, in one implementation of the invention, the ratios of the relative speeds are 1, 1.4, 1.68, 2.1, 2.8, 4.2, 10, 27.2, 10, 4.2, 2.8, 2.1, 1.68, 1.4, and 1, as illustrated in FIG. 3. These ratios denote the relative speeds which the spray nozzle moves across the substrate 102 relative to the slowest speed S1. This set of ratios have been optimized to provide an overall thickness variation of less than +/−5% of the average thickness, regardless the types of resist used.

The overall thickness of the coated photoresist can be independently adjusted by changing the photoresist dispense rate or by altering the photoresist concentration. The photoresist dispense rate controls the amount of resist solution going into the nozzle per unit time. Consequently, it also determines the droplet size. For finer droplets, lower dispense rates are preferred. In the preferred embodiment of the invention, dispense rate settings between 0.75 cubic centimeters (cc) per minute and 2.0 cc per minute were found to be optimal, depending on the type of resist used.

Most commercially available photoresist is diluted to less than twenty (20) centipoise to be dispensed through the spray nozzle. By adding a faster drying solvent, i.e. more volatile, into the photoresist solution, the drying rate of the photoresist is effectively changed. This feature is especially important when coating deep trenches, since the cohesion of wet resist tends to pull photoresist away from edges and corners. Dryer resist compensates for that effect. However, excessively dry resist droplets tend to cause roughness and pores in the resist layer, which will result in significant amount of undercutting and defects in the subsequent etch processes. Therefore, a well-balanced solution is desirable to ensure the success of subsequent etching processes.

One implementation of the invention may employ Futurex NR-9, a negative-tone resist, and Clariant AZ5214, a positive-tone resist. The NR-9 is a cyclohexanone solvent based resist, that is fully compatible with Methyl Ethyl Ketone (MEK), a much more volatile solvent. The AZ5214 is a propylene glycol monomethyl ether acetate (PGMEA) solvent based resist, that is fully compatible with MEK. According to one implementation of the invention, the optimum ratio range of NR-9 to MEK is between one to three (1:3) and one to five and a half (1:5.5), and of AZ5214 to MEK is between one to five (1:5) and one to seven (1:7). It has been discovered that at these dilution ratios, pore formation does not occur, and the coverage is adequate. In one embodiment of the invention, a resist dilution yields a solution with a viscosity between one (1) and three (3) centipoises.

Priming substrate surfaces (e.g., wafers) with adhesion promoters such as hexamethyldisilazane (HMDS) is standard practice in preparation for spin resist coating. This gives good resist adhesion to a substrate surface and prevents undercutting during subsequent wet processing. Control of the deposition prevents over-priming, which typically results in the pulling away of resist from etched feature edges.

Photoresist spun on to a smooth surface is somewhat forgiving of over-priming. However, spray resist processing on surfaces with deeply etched features are much more sensitive to over-priming. Empirical tests measuring water contact angles of primed surfaces before resist applications indicate that, for the same resist, the optimum contact angle for good resist coverage is on the order of ten (10) degrees lower for a surface primed for spray than for a surface primed for spin.

FIG. 4 illustrates the different contact angles of primed surfaces for spin and spray processing, before being coated with photoresist. As illustrated, a water droplet 402 on a surface primed for spin coating has contact angle of β while a water droplet 404 on a surface primed for spray coating has a contact angle of φ, where φ is less than β. For example, according to one embodiment of the invention, the optimum contact angle range φ for water on a primed, oxidized silicon surface is forty (40) to fifty (50) degrees for a spray resist process. By comparison, the optimum contact angle range β for a spin process is in the range of fifty (50) to sixty (60) degrees. This difference in the contact angles is achieved by priming the spray coating substrate with a primer that is less hydrophobic than the primer used for spin coating.

Maintaining a controlled ambient environment, particularly with regard to temperature and humidity, is a very important factor in obtaining a good photoresist coating. Through testing, it has been found that spin coating results are acceptable with most resists when the ambient moisture level is held between thirty percent (30%) and fifty percent (50%) relative humidity. However, it has been found that lower and more tightly controlled humidity levels are better for spray resist applications. This is understood when one considers the combined effect of a highly hydrophobic surface prepared by HMDS and moisture condensation on the resist droplet surfaces. During the critical drying and coalescing phases, the spray resist mist has a much greater overall exposed surface than the same amount of spun resist. In addition, the more highly diluted resist droplets dry at a rapid rate, thus cooling and absorbing moisture from ambient air in quantities much greater than for spun resist. This moisture level in the resist may cause poor adhesion and pullback around corners and edges of hydrophobic surfaces. To counter poor adhesion and pullback around corners and edges, one embodiment of the invention maintains humidity levels lower than thirty percent (30%) relative humidity when spraying photoresist on HMDS primed surfaces.

While HMDS has proven to be a valuable adhesion promoter, it is susceptible to ambient moisture, which hinders its application for spray coating purposes. For instance, in one implementation, it may be necessary to perform the spray coating in a relatively humid environment or less dependence on environmental conditions may be desired.

One implementation of the invention provides a method of spray coating in relatively humid environment. In one embodiment of the invention, SurPass3000™, which is a water-based ionic priming agent made by DisChem Corporation, is used as the priming agent instead of HMDS.

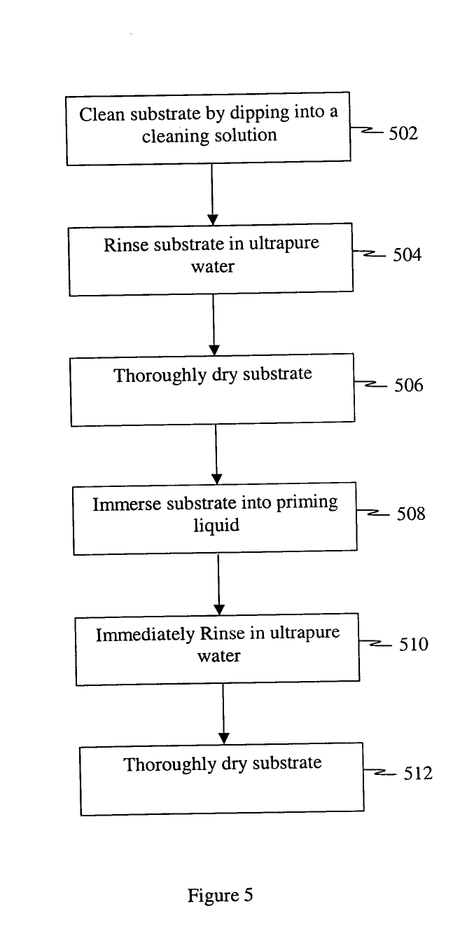

FIG. 5 illustrates one method of priming a substrate prior to spray coating in relatively high humidity environments according to one embodiment of the invention. The substrate is first cleaned by dipping it into a cleaning solution 502. For instance, depending on the initial cleanliness and/or roughness of the substrate, the substrate may be dipped five (5) to fifteen (15) minutes a cleaning solution such as Piranha (peroxide-sulfuric solution). In other implementations, the substrate may be cleaned in oxygen-plasma solution. The substrate is then rinsed with ultrapure water for five (5) to ten (10) minutes 504. The substrate is then thoroughly dried, by either spin or N2 purge for instance 506. Once dried, the substrate is primed by immersion into a priming liquid 508. For example, the substrate may be immersed in SurPass3000 liquid, with gentle agitation, for a period of thirty (30) to ninety (90) seconds. As a rule of thumb, substrates with deep features and high device densities require longer immersion time. The substrate is then immediately rinsed, in flowing ultrapure water for 30 seconds for instance 510. The substrate is then thoroughly dried, by either spin or N2 purge for instance 512.

According to one implementation of the invention, the use of SurPass3000 as a priming agent achieves consistent coating results with relative humidity levels as high as 60%, and undercutting is reduced to less than 1 μm on 15 min. room temperature buffered oxide etch (BOE) samples. Spray coating without any adhesion promoter at this humidity level will invariably delaminate the resist layer.

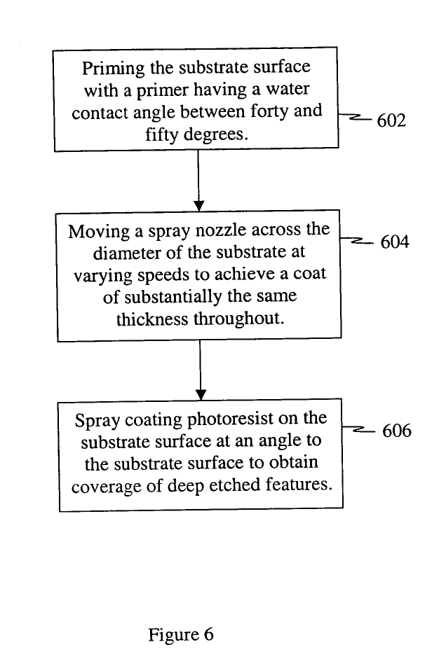

FIG. 6 illustrates a method for depositing photoresist on a substrate according to one embodiment of the invention. The substrate is primed with a primer having a water contact angle between forty and fifty degrees 602. The spray nozzle is moved across the diameter of the substrate at varying speeds to achieve a coat of substantially the same thickness throughout 604. This process is carried out with the spray directed at an angle to the substrate surface to obtain coverage of deep etched features 606.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1. A method comprising:
rotating a substrate at a predefined speed, the substrate having a first surface;
spray coating the first surface of the substrate with a negative-tone photoresist-solvent solution at angle to the first surface to obtain coverage of deep etched features, the negative-tone photoresist to solvent ratio being in the range of one to three and one to five and a half and having a viscosity of between one and three centipoises; and
moving a spray nozzle across the diameter of the first surface of the substrate at varying speeds to achieve a negative-tone photoresist coat of substantially the same thickness throughout the first surface.

2. The method of claim 1 further comprising:
priming the first surface of the substrate with a primer having a water contact angle between forty and fifty degrees.

3. The method of claim 2 wherein, once primed, the photoresist can be sprayed in environments having relative humidity levels as high as sixty percent.

4. The method of claim 1 wherein the negative-tone photoresist is a cyclohexanone-based resist and the solvent is methyl-ethyl-ketone.

5. A method comprising:
rotating a substrate at a predefined speed, the substrate having a first surface;
spray coating the first surface of the substrate with a positive-tone photoresist-solvent solution at angle to the first surface to obtain coverage of deep etched features, the positive-tone photoresist to solvent ratio being in the range of one to five and one to seven and having a viscosity of between one and three centipoises; and
moving a spray nozzle across the diameter of the first surface of the substrate at varying speeds to achieve a positive-tone photoresist coat of substantially the same thickness throughout the first surface.

6. The method of claim 5 further comprising:
priming the first surface of the substrate with a primer having a water contact angle between forty and fifty degrees.

7. The method of claim 6 wherein, once primed, the photoresist can be sprayed in environments having relative humidity levels as high as sixty percent.

8. The method of claim 5 wherein the positive-tone photoresist is a propylene glycol monomethyl ether acetate-based resist and the solvent is methyl-ethyl-ketone.

9. The method of claim 5 wherein the deep etched features are deeper than 20 μm.

10. The method of claim 5 wherein the deep etched features are deeper than 200 μm.

11. A method for coating photoresist on a substrate having deep features comprising:
cleaning the substrate by immersing it into a cleaning solution;
rinsing the substrate in ultrapure water;
thoroughly drying the substrate;
priming the substrate by immersing it into a priming solution, the priming solution having a water contact angle of between forty and fifty degrees,
rinsing the substrate in ultrapure water to remove excess priming solution;
thoroughly drying the substrate; and
spray coating the substrate with a photoresist, wherein the photoresist is sprayed at an angle to the substrate surface.

12. The method of claim 11 wherein
the substrate is immersed into a cleaning solution of peroxide-sulfuric for five to fifteen minutes, and
the substrate is rinsed in ultrapure water for five to ten minutes.

13. The method of claim 11 wherein the deep features are deeper than 20 μm.

14. The method of claim 11 wherein the deep features are deeper than 200 μm.

15. The method of claim 11 wherein the priming solution has a water contact angle of between forty and fifty degrees.

16. The method of claim 11 wherein, once primed, the photoresist can be sprayed in environments having relative humidity levels as high as sixty percent.

17. The method of claim 11 wherein the photoresist is a negative-tone photoresist that is diluted with a solvent, the negative-tone photoresist to solvent ratio being in the range of one to three and one to five and a half.

18. The method of claim 11 wherein the photoresist is a positive-tone photoresist that is diluted with a solvent, the positive-tone photoresist to solvent ratio being in the range of one to five and one to seven.
